(19) United States
(12) Patent Application Publication
(10) Pub. No.: US 2014/0189082 A1
(43) Pub. Date: Jul. 3, 2014

(54) Local Partitioning in a Distributed Communication System

(71) Applicant: FUTUREWEI TECHNOLOGIES, INC., Plano, TX (US)

(72) Inventors: Paul Fullarton, Sunnyvale, CA (US); Sujay Datar, San Jose, CA (US)

(73) Assignee: Futurewei Technologies, Inc., Plano, TX (US)

(21) Appl. No.: 13/730,338

(22) Filed: Dec. 28, 2012

(51) Int. Cl. H04L 12/24

(52) U.S. Cl. CPC H04L 12/2402
USPC 709/223

(57) ABSTRACT

An apparatus for communicating in a distributed system comprises an identifier space and a processor. The identifier space associates data in the distributed system with one or more ranges of values, and the processor distributes cross-locale routing and caching across local nodes in the distributed system using the one or more ranges of values. Also disclosed is a method for communicating in a distributed system. Identifiers for nodes in the distributed system are determined and are associated with locations on an identifier space. Cross-locale routing and caching across local nodes in the distributed system are distributed using the locations on the identifier space. Additionally, an apparatus for retrieving data in a distributed system comprises a processor. The processor is configured to obtain an identifier for the data, locate a position of the identifier on an identifier space, and determine a local node that is responsible for the data.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A communications network may include nodes connected by links that enable communication between users. Each node in a network has a unique identifier (e.g., an Internet Protocol (IP) address) that enables data or connections to be routed to the correct recipient. Communications networks commonly rely on statically configured connectivity and routing, which can be manual, error prone, and rigid. Additionally, communications networks may require communication across different locales (e.g., across a wide area network). This cross-locale traffic can increase communication costs and decrease network performance, for example by increasing system latency.

### SUMMARY

In one embodiment, the disclosure includes an apparatus for communicating in a distributed system. The apparatus comprises an identifier space and a processor. The identifier space associates data in the distributed system with one or more ranges of values, and the processor distributes cross-locale routing and caching across local nodes in the distributed system using the one or more ranges of values.

In another embodiment, the disclosure includes a method for communicating in a distributed system. Identifiers for nodes in the distributed system are determined and are associated with locations on an identifier space. Cross-locale routing and caching across local nodes in the distributed system are distributed using the locations on the identifier space.

In yet another embodiment, the disclosure includes an apparatus for retrieving data in a distributed system. The apparatus comprises a processor that is configured to obtain an identifier for the data, locate a position of the identifier on an identifier space, and determine a local node that is responsible for the data based at least in part on the position.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a local partitioned global network.

FIG. 2 is a schematic diagram of an embodiment of a global identifier space.

FIG. 3 is a flowchart of an embodiment of a data retrieval method.

FIG. 4 is a schematic diagram of an embodiment of a local partitioned global network that communicates across a wide area network.

FIG. 5 is a schematic diagram of an embodiment of a node services component.

FIG. 6 is a schematic diagram of an embodiment of a local cache.

FIG. 7 is a schematic diagram of an embodiment of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, applicants in no way disclaim these technical aspects, and it is contemplated that the present disclosure may encompass one or more of the conventional technical aspects discussed herein.

Disclosed herein are systems and methods that enable local partitioning in a distributed communication system. In an embodiment, nodes and data in a communication system are dynamically mapped to a global identifier space. For example, in one implementation, a hash function is applied to a node or data key to generate a global identifier. The global identifiers can be used to determine which nodes are locally and globally responsible for data. This enables dynamic routing and distribution across a wide area global network resulting in more flexible and easier to manage deployment. Embodiments may also simplify network maintenance and replication across locales resulting in more cost effective availability and reduced cross-locale traffic. Additional features and benefits of embodiments of the present disclosure are discussed below.

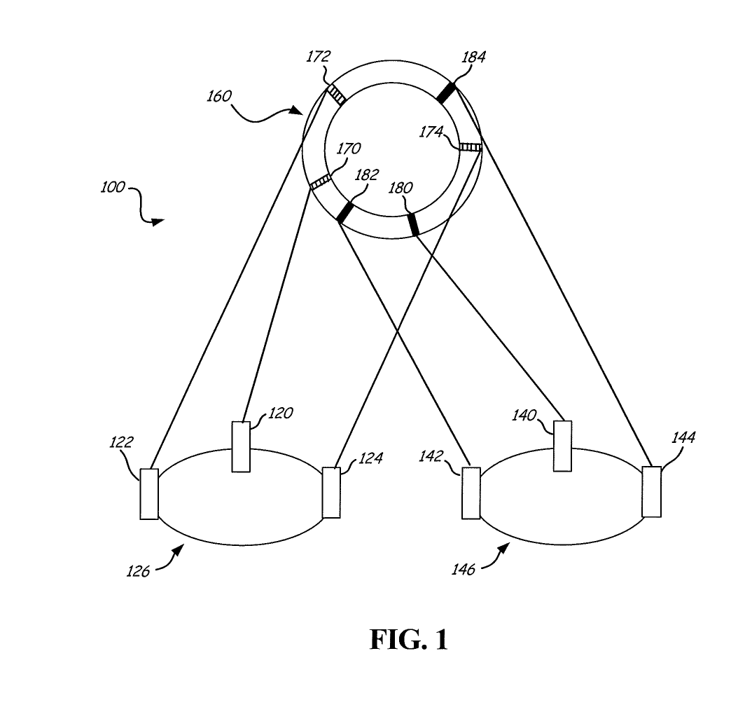

FIG. 1 is a schematic diagram of one embodiment of a local partitioned global network 100. Network 100 includes nodes 120, 122, and 124 in a first locale 126, and nodes 140, 142, and 144 in a second locale 146. Although the figure shows two locales with three nodes each, embodiments are not limited to any number of locales and nodes, and embodiments can include more or fewer locales and nodes than what is shown in the figure. In an embodiment, a locale can include any sub-grouping of nodes. The sub-grouping of nodes may be based on any criteria. For instance, the sub-grouping of nodes may be based on a measure of the quality of the link between nodes (e.g., one or more performance metrics), based on geographic locations, or based on any other factors. Additionally, the sub-grouping of nodes can be either manually or automatically selected. For example, a person could manually assign nodes to a locale, or an automated machine could autonomously assign nodes to a locale randomly or using one or more performance metrics or any other criteria. Embodiments are not however limited to any particular manner of forming a locale, and a locale can include any sub-grouping of nodes.

Each node 120, 122, 124, 140, 142, and 144 is optionally an active electronic device that is attached to network 100 and is capable of sending, receiving, or forwarding information over a communications channel. Some examples of nodes include data circuit-terminating equipment (DCE) such as a modem, hub, bridge, or switch, and data terminal equipment (DTE) such as a digital telephone handset, a printer, a host computer, a router, a workstation, or a server. In one particular embodiment, for illustration purposes only and not by limitation, a node comprises a Unified Communication Application Server. However, embodiments are not limited to any particular type of node.

Network 100 connects nodes 120, 122, 124, 140, 142, and 144 together using links that enable telecommunication between nodes 120, 122, 124, 140, 142, and 144. Each node 120, 122, 124, 140, 142, and 144 in network 100 has a unique address such that messages or connections can be routed to the correct node. The collection of addresses in network 100 is called a global identifier space 160.

Global identifier space 160 is represented in FIG. 1 as a ring. Each node in network 100 is associated with an identifier and is mapped to a location on the global identifier space 160. For instance, nodes 120, 122, 124, 140, 142, and 144 are mapped to the global identifier space locations 170, 172, 174, 180, 182, and 184, respectively. Accordingly, each node in the global network 100 is mapped to the same global identifier space 160.

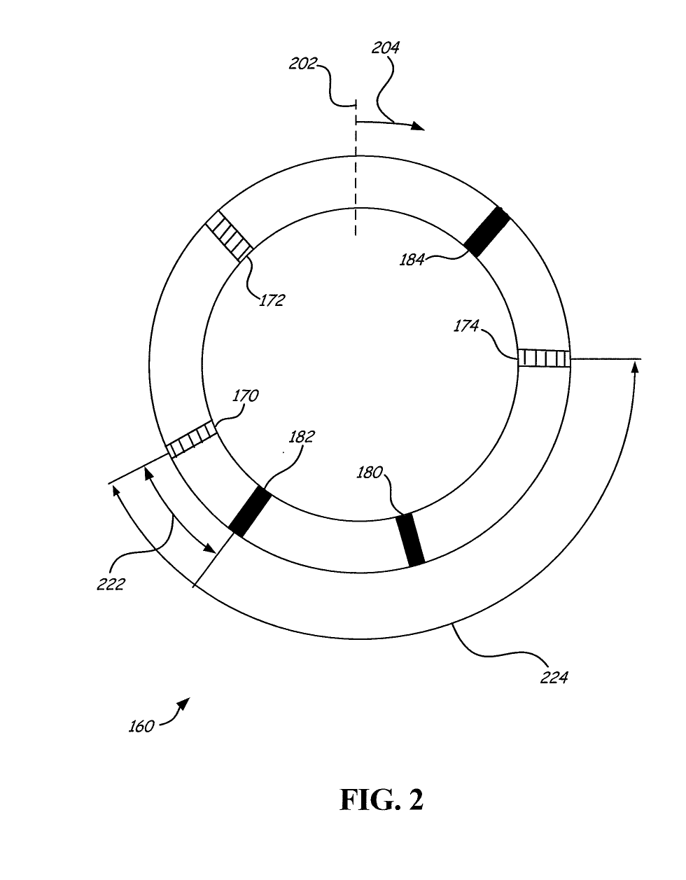

FIG. 2 is a schematic diagram showing a more detailed description of global identifier space 160. In an embodiment, a range (e.g., a range of numbers) is mapped to the global identifier space 160. For instance, global identifier space 160 may include a location 202 that is a start of the range, and the range may increase clockwise around the ring in the direction shown by arrow 204. The range may be selected based on a consistent hashing algorithm. However, the range is not limited to any particular implementation and may include any range.

Each node 120, 122, 124, 140, 142, and 144 (shown in FIG. 1) has an identifier that is located within the range of the global identifier space 160. In one embodiment, the identifiers are generated dynamically by applying a hash function to keys (e.g., IP addresses) associated with the nodes. The hash function is able to receive a variable length key as an input and generate a fixed length hash value that is within the range of the global identifier space 160. For example, consistent hashing can be used to generate identifiers and to determine the location of each identifier on the global identifier space 160. Additionally, identifiers can be generated for any other components associated with a global network (e.g., data, routes, end-point registrations, etc.) and can similarly be mapped to locations on the global identifier space 160.

As previously mentioned, node 120 (shown in FIG. 1) corresponds to the global identifier space location 170. Location 170 is associated with a first interval 222 and a second interval 224. The first interval 222 includes the portion of the global identifier space 160 that is between locations 170 and 182. In an embodiment, node 120 is globally responsible for any data having an identifier that is located within interval 222. For instance, data located at any locale in the distributed system that has an identifier that is within interval 222 is stored to node 120. Accordingly, node 120 is globally responsible for the data corresponding to interval 222 in that if any other node in the distributed system needs the data corresponding to interval 222, the other component knows that it can retrieve the data from node 120.

The second interval 224 includes the portion of the global identifier space 160 that is between locations 170 and 174. Node 120 is locally responsible for any data having an identifier that is located within interval 224. For instance, node 120 provides data having an identifier located within interval 224 to other nodes in its locale (e.g. nodes 122 and 124 in FIG. 1). Node 120 may cache all or a portion of this data or may retrieve the data from the globally responsible nodes as needed. Accordingly, node 120 is locally responsible for the data corresponding to interval 224 in that if any other node within the same locale needs the data corresponding to interval 224, the other node in the same locale knows that it can retrieve the data from node 120.

FIG. 2 only illustrates the local interval 224 and the global interval 222 for node 120 having an identifier location 170. The other nodes in the network may similarly have associated local and global intervals. In an embodiment, a global interval for a node is determined by identifying the location of the node's identifier on the global identifier space, and then moving counterclockwise along the global identifier space until the next node from any locale is encountered. The global interval for the node is the interval between its identifier and the identifier of the next node from any locale located counterclockwise from it.

The local interval for a node is determined by identifying the location of the node's identifier on the global identifier space, and then moving counterclockwise along the global identifier space until the next node from the same locale is encountered. The local interval for the node is the interval between its identifier and the identifier of the next node from the same locale located counterclockwise from it. For example, node 140 (shown in FIG. 1) is associated with an identifier that is located at position 180 on the global identifier space 160. Node 140 is globally responsible for data on the global identifier space interval that is between position 180 and position 174, and node 140 is locally responsible for data on the global identifier space interval that is between position 180 and position 184.

It is worth noting that the methods of assigning local and global intervals described above are given merely for illustration purposes only. Embodiments of the present disclosure can include any method for assigning local and global intervals. For example, in another embodiment, instead of local and global intervals corresponding to a single range of values, local and global nodes may correspond to a group of ranges. For example, one or both of a local and a global interval may include two or more discontinuous ranges of values. The groups of ranges are optionally in the form of a list of ranges or data segments. This may be useful to further randomize the assignments of data elements to nodes. Alternatively, other consistent hashing methods or any other methods of assigning data elements to nodes can also be used. Accordingly, embodiments of the present disclosure cover local and global intervals designed using any methodology and are not limited to the specific examples described above.

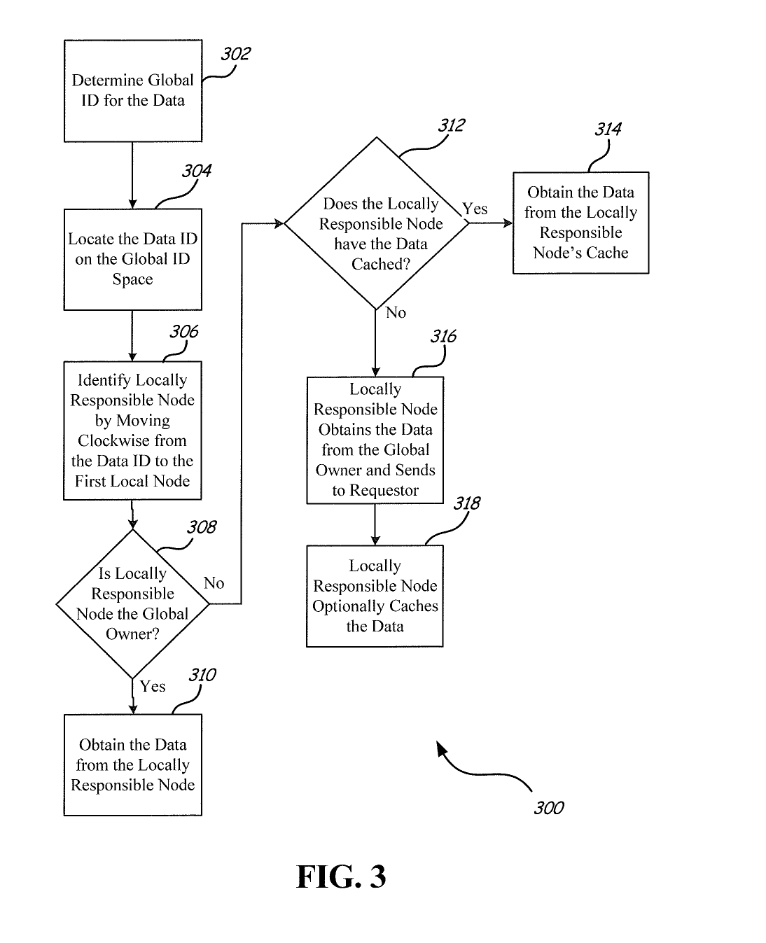

FIG. 3 is a flowchart of one embodiment of a data retrieval method 300. Method 300 can be used by a node of a distributed network system to identify what other node in the distributed network system can provide needed data. Method 300 could be used for example to obtain routing information, end-point registrations, etc. At block 302, a global identifier for the data to be retrieved is determined. For instance, the global identifier may be determined by applying a hash function to a key associated with the data. At block 304, the data's identifier is located on the global identifier space. The locally responsible node is then identified at block 306 by moving clockwise around the global identifier space until the first local node (i.e., the first node within the same locale as the node retrieving the data) is encountered.

If the locally responsible node is also globally responsible for the data, then the method continues from block 308 to block 310 where the data is obtained from the locally responsible node. If the locally responsible node is not globally responsible for the data, then the method continues from block 308 to block 312. At block 312, it is determined whether or not the locally responsible node has the data cached. If the locally responsible node has the data cached, then at block 314 the data is obtained from the locally responsible node's cache. If the locally responsible node does not have the data cached, then at block 316 the locally responsible node obtains the data from the globally responsible node and sends it to the requestor. At block 318, the locally responsible node optionally caches the data so that if the same data is needed again that it can retrieve the data from its cache instead of having to retrieve the data from the globally responsible node.

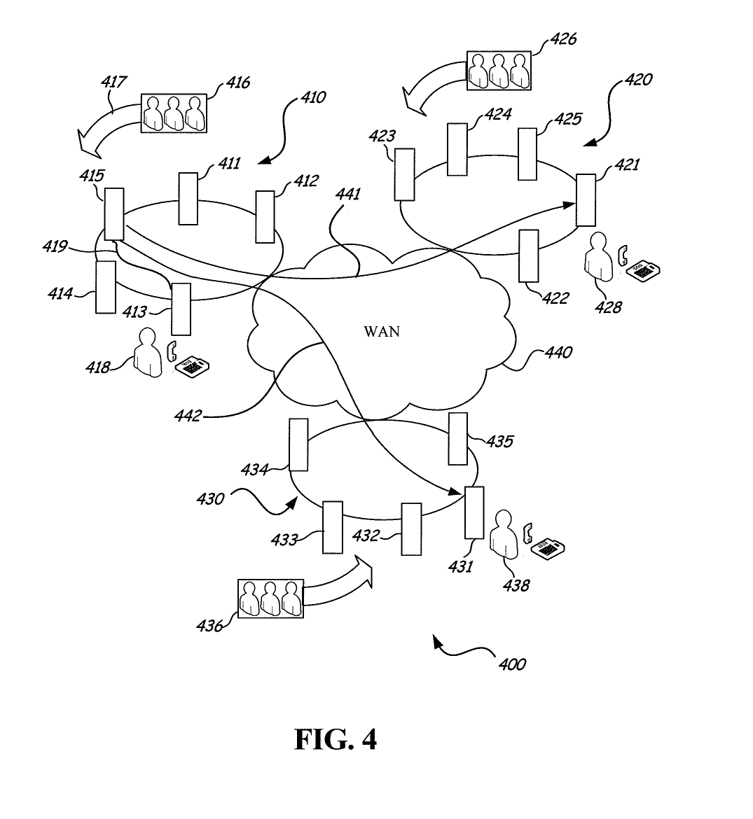

FIG. 4 is a schematic diagram of another embodiment of a local partitioned global network 400. Network 400 includes a first group of nodes 410 in a first locale, a second group of nodes 420 in a second locale, and a third group of nodes 430 in a third locale. The first group of nodes 410 includes the nodes 411, 412, 413, 414, and 415. The second group of nodes 420 includes the nodes 421, 422, 423, 424, and 425, and the third group of nodes 430 includes the nodes 431, 432, 433, 434, and 435. Again, although FIG. 4 shows three locales with five nodes each, embodiments are not limited to any number of locales and nodes, and can include more or fewer locales and nodes than what is shown in the figure.

Each group of nodes is associated with multiple users. For instance, in FIG. 4, the first group of nodes 410 is associated with users 416. The second group of nodes 420 is associated with users 426, and the third group of nodes 430 is associated with users 436. Each group of users is distributed across its corresponding group of local nodes. For instance, arrow 417 represents users 416 being distributed across the first group of nodes 410. In an embodiment, the users can be either automatically or manually distributed within their locale.

Network 400 also includes a wide area network (WAN) 440 that enables communications across the locales. For instance, WAN 440 enables a communication 441 between nodes 415 and 421, and a communication 442 between nodes 415 and 431. In an embodiment, communications across the WAN 440 may be reduced by utilizing the local partitioning and data retrieval methods described above. For example, if user 418 needs to obtain data (e.g., IP addresses) from users 428 and 438 in different locales, user 418 does not need to communicate across the WAN 440. Instead, user 418 can communicate 419 with a local node 415 that is locally responsible for the data. Accordingly, network latency may be reduced by limiting cross-locale communications.

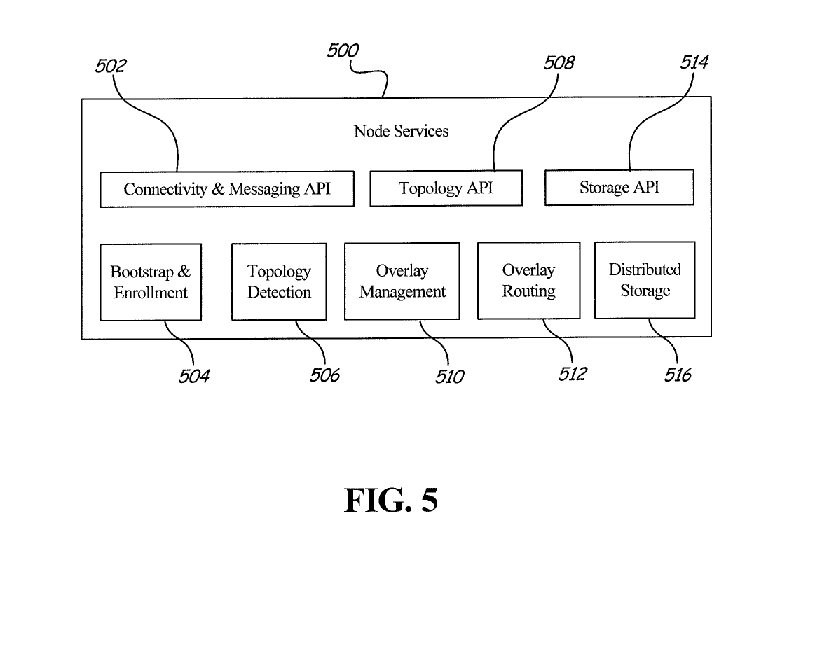

FIG. 5 is a schematic diagram of a node services component 500. In an embodiment, each node provides the same or similar services. Consequently, services are symmetrical and location independent. There are no specialized roles within the network. Some examples of services that may be provided include, but are not limited to, connectivity and messaging application programming interface (API) 502, bootstrap and enrollment 504, topology detection 506, topology API 508, overlay management 510, overlay routing 512, storage API 514, and distributed storage 516. Connectivity and messaging API 502 enables a user to establish a communication session (e.g., a voice over IP (VOIP) communication session) with another user or to send another user a communication (e.g., an email). Boot strap and enrollment 504 enables nodes to join global and local networks and to assume a partition in an automated fashion, which facilitates a system expanding and contracting. Topology detection 506 enables the node to detect the arrangement of nodes and links in the distributed communication system. Topology API 508 enables a user to access the network topology information determined by topology detection 506. Overlay management 510 enables a user to be able to access another network, and overlay routing 512 provides routing information to the user for accessing the other network. Storage API 514 enables a user to store and retrieve data from remote locations, and distributed storage 516 enables network storage to be distributed across different nodes in the distributed system network.

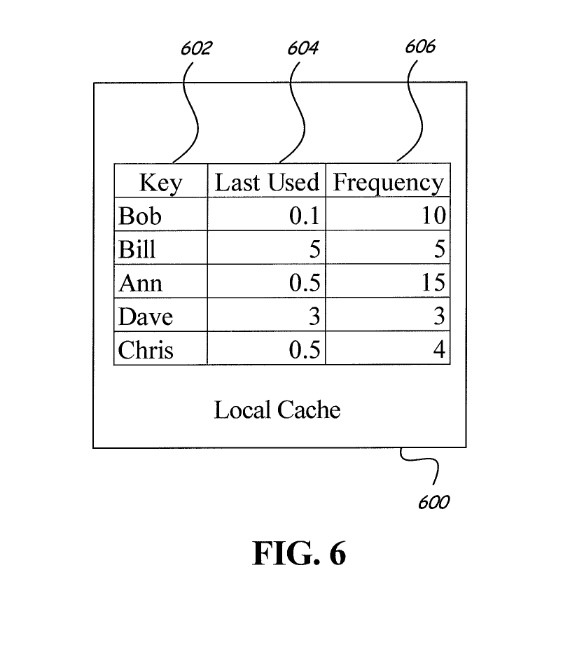

FIG. 6 is a schematic diagram of an embodiment of a local cache 600. Cache 600 includes information associated with keys 602. The keys 602 within the local cache 600 may be associated with keys from different locales. For instance, in the example shown in the figure, the Bob and Bill keys may be associated with a first locale. The Ann and Dave keys may be associated with a second locale, and the Chris key may be associated with a third locale. Accordingly, the local cache 600 can cache information from across the global network. As previously mentioned, this may reduce WAN traffic by enabling a node to retrieve data from a local node instead of having to retrieve it from a remote node across the WAN.

Local cache 600 may also store other information. In the specific example shown in the figure, local cache 600 includes a last used metric 604 and a frequency metric 606 for each key 602. These metrics can be used to manage the cache. For instance, the last used metric 604 can represent how recently data in the cache was used, and the frequency metric 606 can represent how frequently data in the cache is used. The local cache 600 may utilize this information to retain data that was used more recently and/or that is used more frequently. This can improve system performance by making it more likely that the local cache 600 will have data that is needed, as compared to data that has not been used recently and/or is infrequently used.

As has been described above, embodiments of systems and methods provide local partitioning in a distributed communication system. Cross-locale nodes are associated based on overlapping of locally assigned key partitions in a global node identifier space. This enables distributing cross-locale routing and caching across local nodes based on the associations. The dynamic routing and distribution across a wide area global deployment may result in more flexible and easier to manage deployment. Additionally, the location independence of services may result in more efficient mobility. Some other potential benefits include simplifying network maintenance and replication across locations, reduced WAN traffic, and better resiliency to node and WAN failures. Embodiments are not however limited to any particular benefits or features, and may include any one or more of the features described above or shown in the figures.

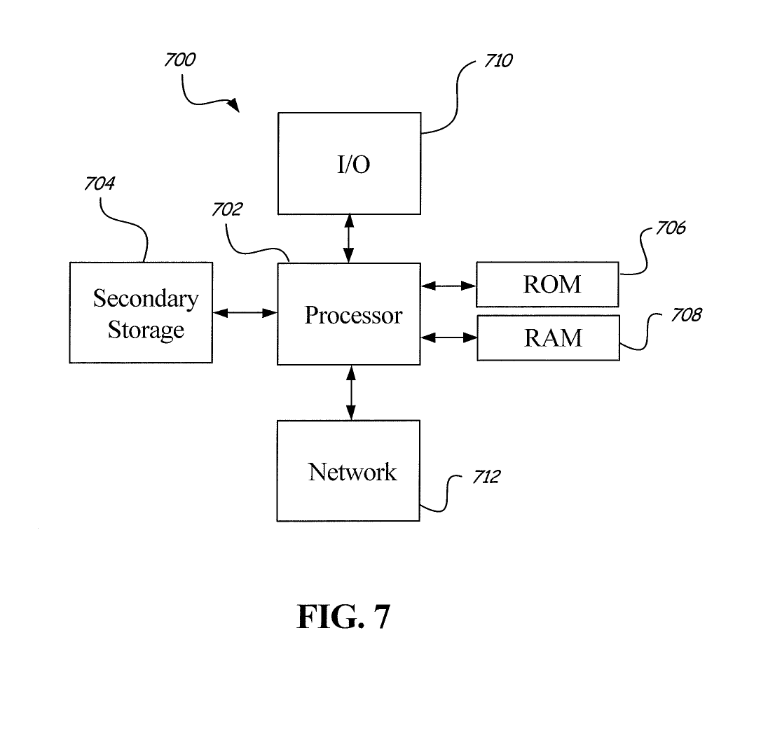

The schemes described above may be implemented on any general-purpose network component, such as a computer or network component with sufficient processing power, memory resources, and network throughput capability to handle the necessary workload placed upon it. FIG. 7 illustrates a schematic diagram of a general-purpose network component or computer system 700 suitable for implementing one or more embodiments of the methods disclosed herein. The general-purpose network component or computer system 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. Although illustrated as a single processor, the processor 702 is not so limited and may comprise multiple processors. The processor 702 may be implemented as one or more general-purpose CPU chips, cores (e.g., a multi-core processor), field-programmable gate arrays (FPGAs), application specific integrated circuits (ASICs), and/or digital signal processors (DSPs), and/or may be part of one or more ASICs. The processor 702 may be configured to implement any of the schemes described herein. The processor 702 may be implemented using hardware, software, or both.

The secondary storage 704 is typically comprised of one or more disk drives or tape drives and is used for non-volatile storage of data and as an over-flow data storage device if the RAM 708 is not large enough to hold all working data. The secondary storage 704 may be used to store programs that are loaded into the RAM 708 when such programs are selected for execution. The ROM 706 is used to store instructions and perhaps data that are read during program execution. The ROM 706 is a non-volatile memory device that typically has a small memory capacity relative to the larger memory capacity of the secondary storage 704. The RAM 708 is used to store volatile data and perhaps to store instructions. Access to both the ROM 706 and the RAM 708 is typically faster than to the secondary storage 704.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus for communicating in a distributed system comprising:
an identifier space that associates data in the distributed system with one or more ranges of values; and
a processor that distributes cross-locale routing and caching across local nodes in the distributed system using the one or more ranges of values.

2. The apparatus of claim 1, wherein the identifier space uses consistent hashing to associate the data with the values in the one or more ranges of values.

3. The apparatus of claim 1, wherein the identifier space identifies which one of the local nodes is locally responsible for the data at each locale in the distributed system.

4. The apparatus of claim 1, wherein the distributed system comprises multiple locales and multiple nodes, and wherein each of the multiple nodes is automatically assigned to one of the multiple locales based on a set of predetermined criteria.

5. The apparatus of claim 1, wherein the identifier space identifies which node in the distributed system is globally responsible for the data in the distributed system.

6. The apparatus of claim 1, wherein the processor automatically distributes users within their locale using the identifier space.

7. The apparatus of claim 1, wherein the processor is used to cache performance metrics associated with the data, and wherein the processor manages a local cache using the performance metrics.

8. A method for communicating in a distributed system comprising:
determining identifiers for nodes in the distributed system;
associating the identifiers with locations on an identifier space; and
distributing cross-locale routing and caching across local nodes in the distributed system using the locations on the identifier space.

9. The method of claim 8, wherein determining the identifiers comprises applying a hash function to node keys to calculate hash values and using the hash values as the identifiers.

10. The method of claim 8, wherein associating the identifiers comprises mapping a range of values to the identifier space and associating each of the identifiers with a value within the range of values.

11. The method of claim 8, wherein distributing the cross-locale routing and caching comprises determining which one of the nodes is locally responsible for routing and caching for each locale.

12. The method of claim 8, wherein distributing the cross-locale routing and caching comprises determining which one of the nodes is globally responsible for routing and caching for the distributed system.

13. An apparatus for retrieving data in a distributed system comprising:
a processor configured to:
obtain an identifier for the data;
locate a position of the identifier on an identifier space; and
determine a local node that is responsible for the data based at least in part on the position.

14. The apparatus of claim 13, wherein the processor is further configured to:
cache the data at the local node; and
obtain the data from the local node's cache.

15. The apparatus of claim 13, wherein the processor is further configured to:
determine a cross-locale node that is responsible for the data based on the position; and
obtaining the data from the cross-locale node using the local node.

16. The apparatus of claim 13, wherein the processor is further configured to determine identifiers for nodes in the distributed system using consistent hashing.

17. The apparatus of claim 13, wherein the processor is further configured to automatically distribute users of the distributed system based at least in part on their locales.

18. The apparatus of claim 13, wherein the processor is further configured to store performance metrics associated with the data in a local cache.

19. The apparatus of claim 13, wherein the processor is further configured to provide a same set of services at each node in the distributed system.

20. The apparatus of claim 13, wherein the processor is further configured to apply a hash function to a key associated with the data to generate a hash value.
